(19) United States
(12) Patent Application Publication
(10) Pub. No.: US 2010/0132853 A1
(43) Pub. Date: Jun. 3, 2010

(54) Method for the Treatment of Metal Sheets

(75) Inventors: Lothar Hanenberg, Duesseldorf (DE); Gerhard Horn, Ratingen (DE); Ulrich Skoda-Dopp, Duisburg (DE); Harald Hauer, Remscheid (DE); Robert Jürgens, Remscheid (DE)

Correspondence Address: COHEN, PONTANI, LIEBERMAN & PAVANE LLP, 551 FIFTH AVENUE, SUITE 1210, NEW YORK, NY, 10176, US

(73) Assignee: SMS Demag AG, Dusseldorf (DE)

(21) Appl. No.: 12/530,962

(22) PCT Filed: Feb. 5, 2008
(86) PCT No.: PCT/DE2008/000237

§ 371 Date: Nov. 2, 2009

(30) Foreign Application Priority Data
Mar. 12, 2007 (DE) 10 2007 012 688.5

(51) Int. Cl. C21D 8/02; C21D 9/46; C21D 1/42

(52) U.S. Cl. 148/567; 148/559

(57) ABSTRACT

A method for the treatment of sheets which are rolled to final dimensions in a roll stand, subsequently undergoing on-line cooling, straightening and heat treatment for homogenization and influencing of microstructure. To improve the heat treatment, the heat treatment is carried out online such that it is decoupled from the preceding cooling and straightening, while taking into account the speed at which the sheet exits from the final workstation upstream, the time at which the heat treatment begins is selected in such a way that the sheet has completely left this final workstation before the sheet is subjected to the heat treatment.

### PRIORITY CLAIM

This is a U.S. national stage of application No. PCT/DE2008/000237, filed on Feb. 5, 2008, which claims Priority to the German Application No.: 10 2007 012 688.5, filed: Mar. 12, 2007; the contents of both being incorporated herein by reference.

### BACKGROUND OF THE INVENTION

1. Field of the Invention

The invention is directed to a method for the treatment of metal sheets that are rolled to final dimensions in a roll stand, which subsequently undergo on-line cooling, straightening, and heat treatment for homogenization and influencing of microstructure.

2. Prior Art

In conventional sheet mills, the heat treatment arrangements (e.g., heating and cooling units) are located separate from the direct production flow exiting the rolling heat in separate locations on the other side of the cooling beds.

The idea of normalizing from the rolling heat already existed in the 1970s, as disclosed by Pavlidis, Freier and Petersen, “Stahl u. Eisen” 95 (1975), pages 215-21.

It is known from EP 1452247A1 to heat the metal sheet inductively after cooling and subsequent straightening. The straightening and heating process is linked with the subsequent heating, i.e., during the inductive heating of a portion of the sheet which is already straightened, the rest of the sheet length is still in the straightening process.

### SUMMARY OF THE INVENTION

It is an object of the invention to improve heat treatment in an online process.

In a method for treatment of metal sheets that are rolled to final dimensions in a roll stand, which subsequently undergoing on-line cooling, straightening, and heat treatment for homogenization and influencing of microstructure. The above-stated object is met in that the heat treatment is carried out online such that it is decoupled from the preceding cooling and straightening, for which purpose, while taking into account the speed at which the sheet exits from the final working station upstream, the time at which the heat treatment begins is selected such that the sheet has completely left this final working station before being subjected to the heat treatment.

According to one embodiment of the invention, an inductive heating arrangement is arranged directly in the production flow after the straightening and cooling units. The cooled and straightened, or straightened and cooled, finished sheet coming from the roll stand is heated. By this heat treatment, the material properties are deliberately influenced by the thickness and width at a different time than the prior working. In this way homogenization of the material characteristics is improved, or different microstructures are produced over the thickness cross section.

Accordingly, in contrast to the prior art, the inventive heat treatment is decoupled from the preceding working steps, but is still carried out online.

In this way, the heat treatment can be substantially improved because the speed at which the metal sheet exits from the final working step, for example, straightening, has no bearing on the time period of the heat treatment or the speed at which it takes place, depending on the online process.

The supply of heat for the heat treatment is preferably carried out inductively.

The heat supply is advantageously carried out by induction coils inserted into the production line, namely, on the upper side and/or underside of the metal sheet.

To configure the heat treatment in a more sensitive manner, the induction coils serving to supply heat should be independently switchable.

The invention will be described in the following with reference to an embodiment example.

### BRIEF DESCRIPTION OF THE DRAWINGS

In the drawings:

FIG. 1 is a schematic view of a process layout;

FIG. 2 is a detail of the inductive heating arrangement; and

FIG. 3 is a graph showing the heating over the metal sheet cross section with a sheet thickness of 25 mm and a heating from 340° C. to 650° C.

### DETAILED DESCRIPTION OF THE DRAWINGS

The roll stand 1 and the inductive heating arrangement 4 are shown individually in FIG. 1.

A cooling line and a hot straightening machine or—in reverse order—a hot straightening machine and a cooling line are indicated by 2 and 3.

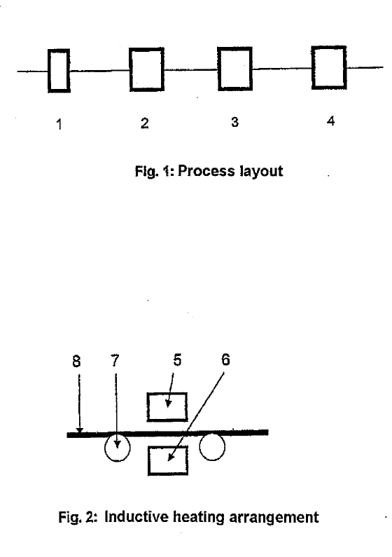

As is shown in FIG. 2, the inductive heating arrangement comprises a plurality of induction coils 5 and 6 which are arranged below and above the roller path 7. The finished metal sheet is designated by 8 in the schematic drawing.

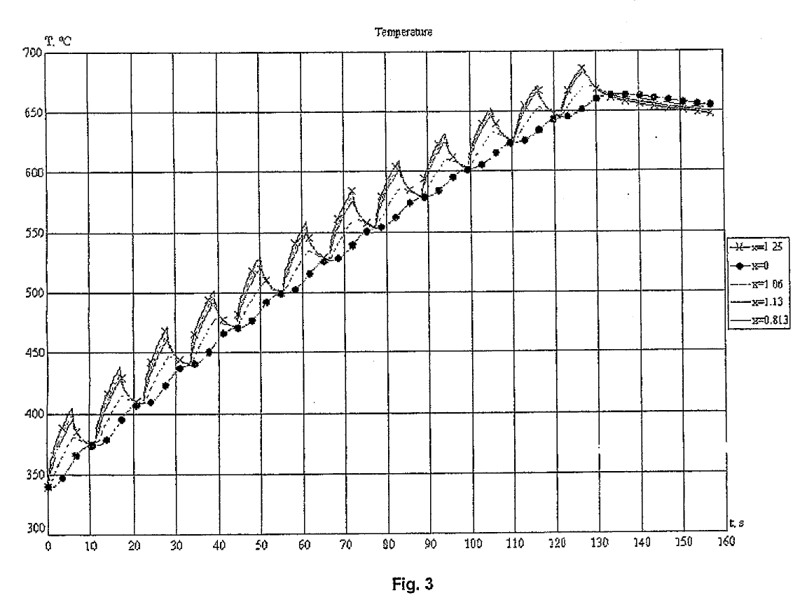

FIG. 3 shows different heating of the core and of the top surface of a metal sheet, i.e., starting from the temperature of 350° C. when entering the heat treatment arrangement, complete homogenization of the temperature to 650° C. is first achieved after about 130 seconds. A dwell period or treatment period such as this can only be achieved when the heat treatment is not restricted in time with respect to speed by the preceding process steps, that is, the working stations arranged and used upstream.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method to treat metal sheets in a production line comprising:
rolling a metal sheet to a final dimension in a roll stand;
on-line cooling the metal sheet;
straightening the metal sheet; and
heat treating the metal sheets for homogenization and influencing of microstructure, the heat treating decoupled from the preceding cooling and straightening and beginning at a time selected such that the metal sheet has completely left a final upstream workstation before the sheet is subjected to the heat treating,
the heat treating being performed based at least in part on a speed at which the metal sheet exits from the final upstream workstation.

9. The method according to claim 8, wherein a supply of heat for the heat-treating is provided inductively.

10. The method according to claim 9, wherein the supply of heat is provided by induction coils.

11. The method according to claim 8, wherein the heat is supplied to at least one of an upper side and an underside of the metal sheet.

12. The method according to claim 8, wherein each of a plurality of induction coils configured to supply of heat for the heat-treating are switchable independently from one another.

13. The method according to claim 8, wherein the final workstation is the straightening of the finished metal sheet.

14. The method according to claim 8, wherein the final workstation is the cooling of the finished metal sheet.

15. The method according to claim 10, wherein the induction coils are in the production line.

16. The method according to claim 10, wherein the heat is supplied to at least one of an upper side and an underside of the metal sheet.
